(19) United States
(12) Patent Application Publication
(10) Pub. No.: US 2010/0014112 A1
(43) Pub. Date: Jan. 21, 2010

(54) IMAGE PROCESSING APPARATUS AND CONTROL METHOD THEREOF AND IMAGE PROCESSING SYSTEM

(75) Inventor: Hiroyoshi Yoshida, Tokyo (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/298,985

(22) PCT Filed: May 29, 2007
(86) PCT No.: PCT/JP2007/061396

§ 371 Date: Oct. 29, 2008

(30) Foreign Application Priority Data
Jun. 19, 2006 (JP) 2006-169388

(51) Int. Cl. G06F 15/00

(52) U.S. Cl. 358/1.15; 358/448

(57) ABSTRACT

Device B requests a network service of device A, and devices B and A are set in a client mode and server mode, respectively. Further, a mode is set in which the console unit of device A is controlled from that of device B, and image data scanned and created by the scanner of device B is processed as image data scanned by that of device A. In response to process start designation input from the console unit of device B, device A designates device B to scan an image using the scanner of device B. In response to the designation, device B transmits image data scanned by the scanner of device B to device A. Device A executes a process corresponding to setting information for the image data.

### TECHNICAL FIELD

The present invention relates to an image processing apparatus capable of connecting to a network, that has at least a console unit and image scanner, a control method thereof, and an image processing system.

### BACKGROUND ART

An MFP (Multi-Functional Peripheral) not only functions as a single device, but also connects to a network and operates in accordance with copy and print instructions received via the network. When issuing a copy instruction to such a device via the network, no user-satisfactory process can be achieved unless the capability of the partner device, which executes the instruction, is confirmed. For example, capability information on whether the partner device is capable of color copy, has a staple function of stapling printed sheets, or is capable of double-sided printing must be acquired in advance (see Japanese Patent Laid-Open No. 11-4335).

There is proposed a capability exchange protocol to exchange capability information. However, in a case that a new service or function not assumed in the capability exchange protocol is added, it is impossible to exchange information on this capability. Hence, a demand has arisen for a system capable of grasping the capability of a partner device regardless of an existing capability exchange protocol, and implementing various capabilities and services by a plurality of devices in cooperation with each other.

### DISCLOSURE OF INVENTION

It is an object of the present invention to solve the problems of the prior art.

A characteristic feature of the present invention is to implement various capabilities and services by a plurality of devices in cooperation with each other regardless of an existing capability exchange protocol.

According to the present invention, there is provided with an image processing apparatus which has at least a console unit and an image scanner and can connect to a network, comprising:

a creation unit configured to create image data corresponding to a document by driving the image scanner in accordance with a scan parameter upon receiving an image scan request including the scan parameter of the document;

a transmission unit configured to transmit the image data created by the creation unit to a transmitting source which has issued the image scan request via the network; and

a notification unit configured to notify the transmitting source to process an operation using the console unit as an operation on a console unit of the transmitting source.

According to the present invention, there is provided with a control method in an image processing apparatus which has at least a console unit and an image scanner and can connect to a network, comprising:

a creation step of creating image data corresponding to a document by driving the image scanner in accordance with a scan parameter upon receiving an image scan request including the scan parameter of the document;

a transmission step of transmitting the image data created in the creation step to a transmitting source which has issued the image scan request via the network; and

a notification step of notifying the transmitting source to process an operation using the console unit as an operation on a console unit of the transmitting source.

The disclosure of the invention does not enumerate all features of the present invention. Other claims of the present invention and combinations of characteristic parts can also constitute the present invention.

Further features of the present invention will become apparent from the following description of exemplary embodiments with reference to the attached drawings.

### BRIEF DESCRIPTION OF DRAWINGS

The accompanying drawings, which are incorporated in and constitute a part of the specification, illustrate embodiments of the invention and, together with the description, serve to explain the principles of the invention.

FIG. 1 is a chart for explaining a mechanism of building an NS system and an operation in the NS system according to an embodiment;

FIG. 2 is a block diagram showing the configuration of the main part of an MFP according to the embodiment;

FIG. 3 depicts a side sectional view for explaining the hardware configuration of the MFP according to the embodiment;

FIG. 4 depicts a view showing the outer appearance of the console unit of the MFP according to the embodiment;

FIG. 5 depicts a view showing an example of a function selection screen displayed on the display of device B according to the embodiment;

FIG. 6 depicts a view showing an example of a screen displayed on the display of device B during search according to the embodiment;

FIG. 7 depicts a view showing an example of a FAX operation screen displayed on the display of the console unit of device B according to the embodiment;

FIG. 8 depicts a view showing an example of the display of a warning message displayed on the display of device A according to the embodiment;

FIG. 9 is a flowchart for explaining a process in an MFP according to the first embodiment of the present invention;

FIG. 10 is a flowchart for explaining a process in the MFP according to the first embodiment;

FIG. 11 depicts a view showing an example of a copy function setup screen displayed on the display of the console unit of an MFP when the copy function is designated according to the second embodiment of the present invention;

FIG. 12 depicts a view showing an example of a sort setup screen displayed on the console unit of the MFP according to the second embodiment;

FIG. 13 depicts a view showing an example of a screen representing a state in which “staple sort” displayed on the console unit of the MFP is designated according to the second embodiment;

FIG. 14 depicts a view showing an example of a staple sort setup screen displayed on the console unit of the MFP according to the second embodiment;

FIG. 15 depicts a view showing an example of a screen for selecting the size of a print sheet subjected to stapling and sorting by a detected device according to the second embodiment; and

FIG. 16 depicts a view showing an example of an operation screen when an execution device executes a copy process according to the second embodiment.

### BEST MODE FOR CARRYING OUT THE INVENTION

The preferred embodiments of the present invention will be described below in detail with reference to the accompanying drawings. The following embodiments do not limit the claims of the present invention, and not all combinations of features described in the embodiments are essential in solving means of the present invention.

The following embodiments will be explained by exemplifying an MFP (Multi-Functional Peripheral) having copy, facsimile, print, and scanner functions. However, the present invention is not limited to the MFP.

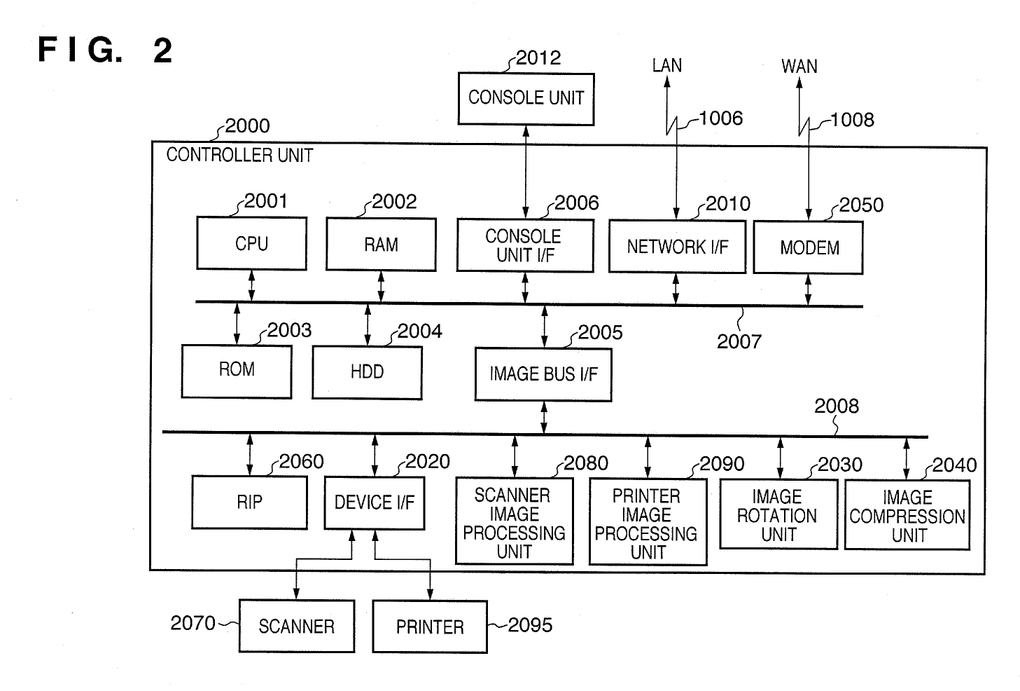

FIG. 2 is a block diagram showing the configuration of the main part of the MFP according to the embodiment.

The MFP comprises a controller unit 2000 which controls the overall MFP. A scanner 2070 serving as an image input device and a printer 2095 serving as an image output device are connected to the controller unit 2000. A console unit 2012 has an operation button operated by the user, and a display for displaying a message and the like to the user and also functioning as a touch panel. The console unit 2012 is also connected to the controller unit 2000. The controller unit 2000 performs control to implement a function of outputting received data to the printer 2095 to print it, and a copy function of transmitting image data scanned by the scanner 2070 via a network or outputting the image data to the printer 2095 to print it. The controller unit 2000 also performs control to transmit/receive image information and device information to/from a LAN 1006 and public line (WAN) 1008.

The controller unit 2000 includes a CPU 2001. The CPU 2001 loads an OS (Operating System) from an HDD (Hard Disk Drive) 2004 to a RAM 2002 and executes the OS in accordance with a boot program stored in a ROM 2003 upon power-on. On the OS, the CPU 2001 executes various processes by loading an application program stored in the HDD 2004 to the RAM 2002 and executing it. The RAM 2002 further provides a work area for the CPU 2001, and an image memory area for temporarily storing image data. The HDD 2004 stores an OS, various application programs, and image data.

The ROM 2003, RAM 2002, and HDD 2004 are connected to the CPU 2001 via a system bus 2007. Further, a console unit I/F (console unit interface) 2006, network I/F (network interface) 2010, modem 2050, and image bus I/F (image bus interface) 2005 are connected to the CPU 2001. The console unit I/F 2006 controls an interface with the console unit 2012 having the touch panel, and outputs, to the console unit 2012, image data to be displayed on the display of the console unit 2012. The console unit I/F 2006 sends, to the CPU 2001, information input from the user via an operation button on the console unit 2012. The network I/F 2010 is connected to the LAN 1006, and exchanges information with devices on the LAN 1006 via the LAN 1006. The modem 2050 is connected to the public line 1008, and inputs/outputs information via the public line 1008.

The image bus I/F 2005 is a bus bridge which connects the system bus 2007 to an image bus 2008 for transferring image data at high speed, and converts a data format. The image bus 2008 is a PCI bus or IEEE1394. A raster image processor (RIP) 2060, device I/F 2020, scanner image processing unit 2080, printer image processing unit 2090, image rotation unit 2030, and image compression unit 2040 are connected to the image bus 2008. The RIP 2060 is a processor which converts a PDL (Page Description Language) code into a bitmap image. The device I/F 2020 connects the scanner 2070 and printer 2095. The device I/F 2020 performs synchronous/asynchronous transfer control of image data. The scanner image processing unit 2080 performs correction, processing, and editing on image data input from the scanner 2070. The printer image processing unit 2090 performs correction, resolution conversion, and the like on image data to be output to the printer 2095 in accordance with the characteristics of the printer 2095. The image rotation unit 2030 rotates image data. The image compression unit 2040 has a function of compressing binary image data into encoded data by JBIG, MMR, MH, or the like, and decompressing the encoded data.

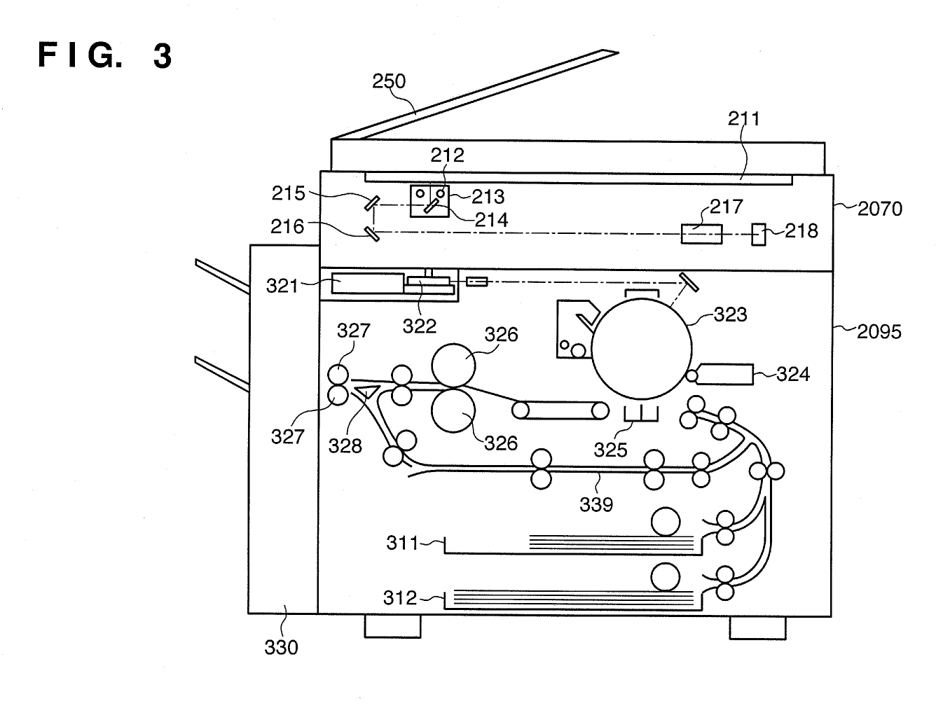

The hardware configuration of the MFP according to the embodiment will be explained with reference to FIG. 3.

FIG. 3 depicts a side sectional view for explaining the hardware configuration of the MFP according to the embodiment. As shown in FIG. 3, the scanner 2070 and printer 2095 are integrated.

The scanner 2070 comprises a document (original) feed unit 250. The document feed unit 250 feeds document sheets one by one from the first sheet onto a platen glass 211, and every time a document sheet (original) is read, discharges it from the platen glass 211 to a discharge tray (not shown). When a document sheet is fed onto the platen glass 211, the scanner 2070 turns on a lamp 212 to read the document sheet by one main scanning. After reading the image by one main scanning, a moving unit 213 moves in the subscanning direction (longitudinal direction in FIG. 3). As the moving unit 213 moves in the subscanning direction, the entire document sheet on the platen glass 211 is scanned and read. During read scanning, reflected light from the document sheet is guided to a CCD image sensor (CCD) 218 via mirrors 214, 215, and 216 and a lens 217, forming an image on the document sheet onto the image sensing plane of the CCD 218. The CCD 218 converts the formed document image into an electrical signal, and outputs the electrical signal. The electrical signal (image signal) is input to the scanner image processing unit 2080 via the device I/F 2020, and undergoes a predetermined image process.

The printer 2095 will be explained. A laser driver 321 drives a laser-emitting unit 322 based on image data processed by the printer image processing unit 2090. A laser beam emitted by the laser-emitting unit 322 is reflected by a rotating polygon mirror, and scans a photosensitive drum 323. The laser beam forms an electrostatic latent image on the photosensitive drum 323, and the electrostatic latent image is visualized into a toner image with toner supplied from a developing unit 324. In synchronism with the laser beam irradiation timing, a print sheet is fed between the photosensitive drum 323 and a transfer unit 325 from a print sheet cassette 311 or 312 via the conveyance path. The transfer unit 325 transfers the toner image on the photosensitive drum 323 onto the fed print sheet. The print sheet bearing the toner image is sent to a pair of fixing rollers (heat roller and press roller) 326 via a conveyer belt. The pair of fixing rollers 326 thermally presses the print sheet to fix the toner image on the print sheet onto it. The print sheet, having passed through the pair of fixing rollers 326, is delivered to a delivery unit 330 via a pair of delivery rollers 327. The delivery unit 330 is a sheet processing device capable of performing post-processes such as sorting and stapling.

When the double-sided print mode is set, the transferred/fixed print sheet is conveyed to the pair of delivery rollers 327, and the rotational direction of the pair of delivery rollers 327 is reversed to guide the print sheet to a refeed conveyance path 339 via a flapper 328. The print sheet guided to the refeed conveyance path 339 is fed again between the photosensitive drum 323 and the transfer unit 325 at the above-described timing. Then, a toner image is transferred onto the reverse surface of the print sheet. In this manner, the printer 2095 can perform color double-sided printing, and post-processes such as sorting and stapling for a printed sheet.

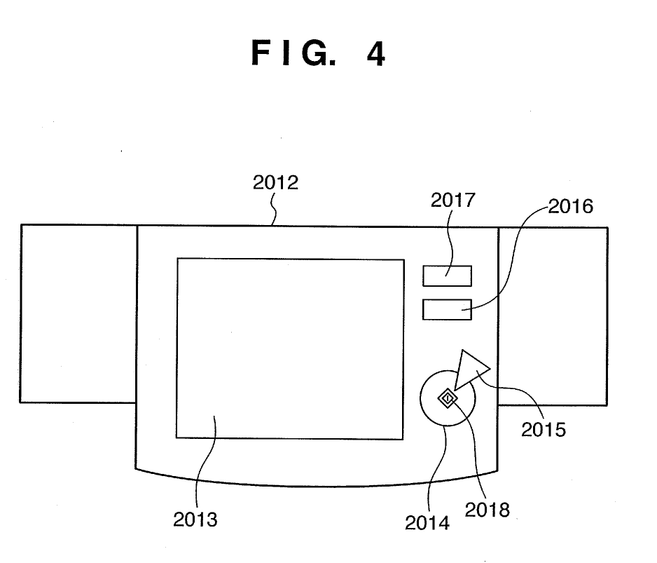

FIG. 4 depicts a view showing the outer appearance of the console unit 2012 of the MFP according to the embodiment.

A liquid crystal display 2013 is covered with a touch panel sheet on it, and displays the operation screen of the MFP. When the user touches a key displayed on the screen with a finger or the like, the liquid crystal display 2013 notifies the console unit I/F 2006 of the controller unit 2000 of position information of the key. Then, the CPU 2001 can discriminate the key operated on the console unit 2012. A start key 2014 is used to start a document scan operation, FAX transmission, and the like. An LED 2018 in two colors, green and red, is arranged at the center of the start key 2014, and the illumination color of the LED 2018 represents whether the start key 2014 is available. A stop key 2015 is pressed to stop an operation in progress. An ID key 2016 is used to input the user ID of a user. A reset key 2017 is used to initialize settings from the console unit 2012.

Various functions provided by the MFP according to the embodiment will be explained.

<Pull Scan Service>

The pull scan service is a service to transmit image data created by scanning a document by the MFP, via the network I/F 2010 to a client which has requested the pull scan service.

The client activates a scanner driver, specifies an MFP, and transmits a scan service request including scan parameters to the MFP. Upon receiving the pull scan service request including scan parameters via the network, the CPU 2001 determines, based on the received scan parameters and the MFP status, whether the service is feasible. If the CPU 2001 determines that the service is not feasible, it sends back, to the requesting client, an MFP status or scan parameter which is the reason why the service is not feasible. If the CPU 2001 determines that the service is feasible, it sets the received scan parameters for the scanner 2070 of the MFP. The scanner 2070 scans a document, and the scanner image processing unit 2080 corrects image data created by scanning, thus creating output image data. Every time one document sheet is scanned, the MFP transmits the output image data to the pull scan-requesting client. At the end of scanning all document sheets, the MFP transmits a pull scan end notification to the client.

The scan parameters include information designating the scan resolution, scan color, scan tone, scan size (including “auto”), color space information (e.g., NTSC/Lab) of output image data, double-sided scanning, mixed document sizes, and the like.

<Virtual Scanning Mode>

In the virtual scanning mode, image data received via the network I/F 2010 is processed as if it were scanned and read by the scanner 2070 of the MFP.

When the MFP enters the virtual scanning mode, the CPU 2001 changes the status of the scanner 2070 to “busy”. Upon receiving image data via the network I/F 2010, the CPU 2001 stores the received image data in the HDD 2004, regards the image data as one input from the scanner 2070, adds image data storage position information to the image data, and sends the resultant image data to a program waiting for scanning of the document. Even if the program does not have any special mode such as the virtual scanning mode, the program waiting for scanning of the document can operate similarly to a case where the scanner 2070 of the MFP scans a document.

<Console External Controlled Mode>

Upon receiving a console external controlled mode request, the CPU 2001 determines, for example, whether the user currently operates the console unit 2012 or another user occupies the MFP. In such a case, the CPU 2001 does not accept the request. If the CPU 2001 determines that the MFP can shift to the console external controlled mode, it sets the console external controlled mode. If the CPU 2001 determines that the MFP cannot shift to the console external controlled mode owing to the above-mentioned reason, it sends back the reason to the requesting source (console client).

When the MFP shifts to the console external controlled mode, the CPU 2001 also transmits console control information exchanged between the CPU 2001 and the console unit I/F 2006 to the external console client via the network I/F 2010. Upon receiving information on the console unit 2012 via the network I/F 2010, the CPU 2001 converts the information into console control information, and transmits the console control information to the console unit I/F 2006. As a result, the console unit 2012 of the MFP main body can be operated from the console client (another device) via a network or the like. An example of this process is VNC (Virtual Network Computing). The VNC is software for remote-controlling the screen of another computer connected via a network.

<Slave Console Mode>

The slave console mode is not only a kind of console external controlled mode described above, but also a mode in which no operation is permitted on the console unit 2012 of the MFP.

When the MFP enters the slave console mode, the CPU 2001 stops the operation of a key input information creation program which detects inputs from the touch panel 2013 and hard keys 2014 to 2016 and 2018 of the console unit 2012. This inhibits any operation using the console unit 2012 of the MFP, and the console unit 2012 is controlled in accordance with control information from a console client (another device on a network). However, the operation of the key input information creation program is active for only an input from the reset key 2017 of the console unit 2012 of the MFP. When the user presses the reset key 2017 in the slave console mode, the display 2013 of the console unit 2012 displays a message “During external controlled mode, you can request release of control of the control device by pressing the reset key while this screen is displayed.” for a predetermined time period. If the user presses the reset key 2017 again while this message is displayed, the CPU 2001 displays again a message “stop external controlled mode” and a soft key ([OK] key) for a predetermined time period.

Since the slave console mode is a kind of console external controlled mode, the console client also displays these messages. Even if the user touches the displayed soft key [OK] on the touch panel 2013 of the console unit of the MFP, no input is accepted because the key input information creation program of the MFP stops. Thus, the user can designate this soft key only from the console client. If the user presses (designates) the soft key [OK] displayed on the display of the console client, the slave console mode terminates.

If the user presses the reset key 2017 of the device (MFP) in the slave console mode, the console client in the slave console mode displays a message of whether to stop the slave console mode, prompting the user to confirm it. If the user of the console client approves the stop of the slave console mode, the slave console mode can be canceled.

<Console Client Mode>

In the console client mode, the console unit of another device (external device) is controlled by requesting the above-described console external controlled mode of an external device connected via a network from the console unit 2012 of the MFP.

Upon accepting a console client mode request from the console unit 2012 of the MFP, the CPU 2001 issues a console external controlled request to the designated external device. When the external device accepts the request, the CPU 2001 transmits the contents of communication between the CPU 2001 and the console unit I/F 2006 to the external device via the network I/F 2010. To the contrary, when the CPU 2001 receives display information on the console unit of the external device via the network I/F 2010, it converts the display information into display data for the console unit 2012 of the MFP. The CPU 2001 outputs the display information to the console unit I/F 2006, enabling an operation on the console unit of the external device from the console unit 2012 of the MFP. An example of this process is VNC.

In this state, if the user presses the reset key 2017 of the console unit 2012 of the MFP, the key code of the reset key 2017 is transmitted as control information to the external device via the network I/F 2010. Upon receiving the control information, the external device displays a message “During external controlled mode, you can request release of control of the control device by pressing the reset key while this screen is displayed.” If the user presses the reset key 2017 again on the external device while this message is displayed, the external device displays again a message “stop external controlled mode” and a soft key ([OK] key) for a predetermined time period. If the user presses (designates) the [OK] key, the key code is transmitted as control information to the console server of the external device. Then, the console external controlled mode in the external device terminates, and the slave console mode in the MFP also terminates.

<Architecture and Standard Operation of Network Service System>

A network service (to be referred to as NS hereinafter) is to provide one service to the user by a scanner and its output (including data storage and data processing) service provided by a plurality of devices in cooperation with each other.

This system is implemented by devices connected to a network according to the embodiment. A device which provides the output service will be called an NS server, and a device which provides the scanner function will be called an NS client. A state in which the NS client cooperates with the NS server in the network will be called a state in which the NS system is built.

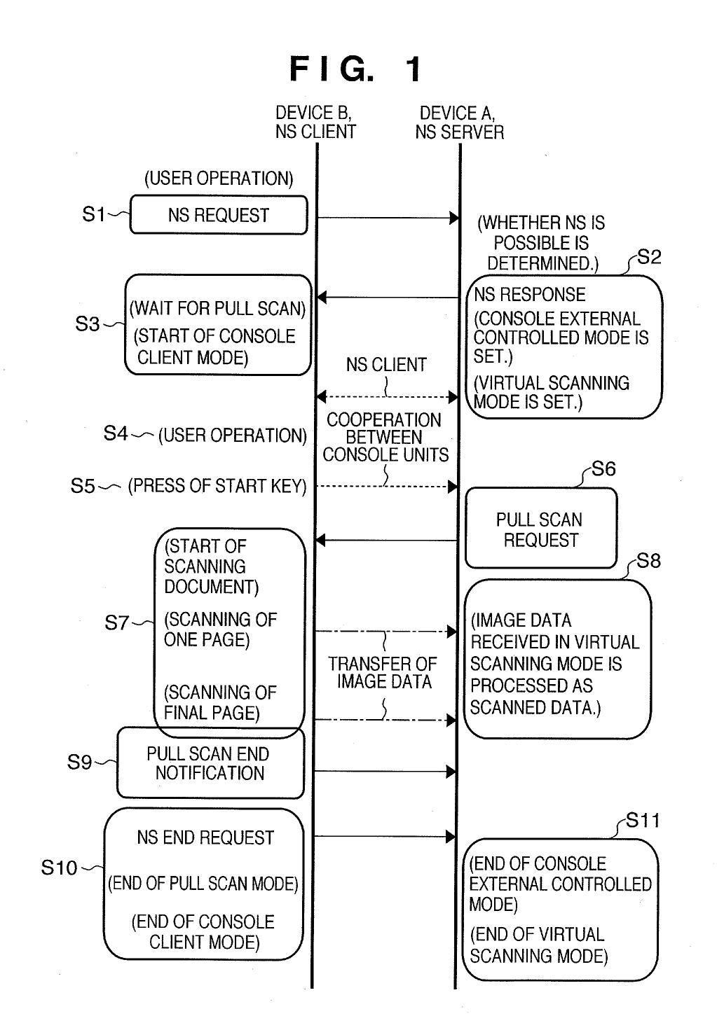

FIG. 1 is a chart for explaining a mechanism of building the NS system and an operation in the NS system according to the embodiment. Devices A and B connected to a network will be exemplified. Devices A and B correspond to MFPs described above.

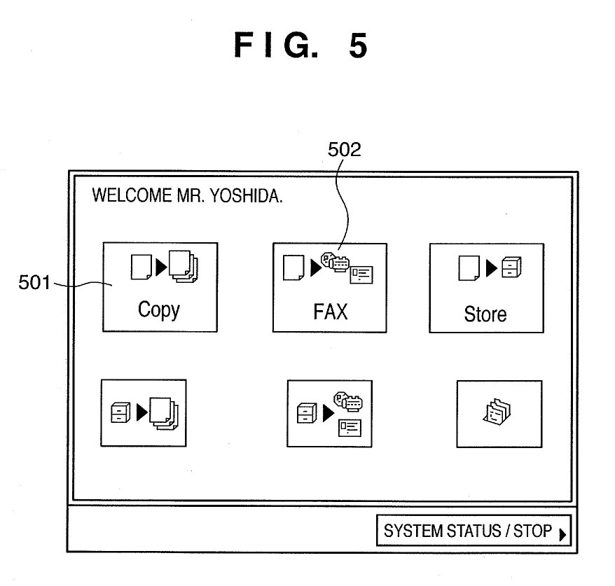

FIG. 5 depicts a view showing an example of a function selection screen displayed on the display 2013 of device B. The function selection screen shows a plurality of icons for designating respective functions.

In FIG. 5, an icon 501 designating the copy function, an icon 502 designating the FAX function, and the like are displayed. Assume that the user of device B designates the icon 502 to select the FAX function, and device B has a communication function via the network but is not connected to any FAX line. In this case, device B searches NS servers on the network for a device having the FAX function.

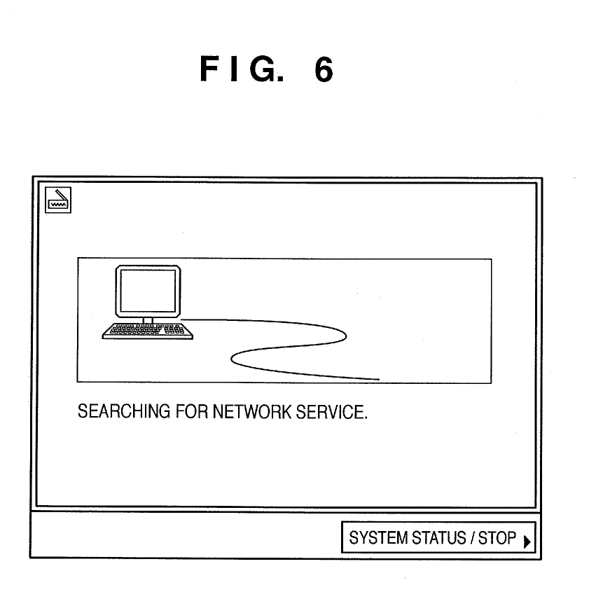

FIG. 6 depicts a view showing an example of a screen displayed on the display 2013 of device B during search. In FIG. 6, the display 2013 shows a message that search for the network service is in progress.

If device A having the FAX function is detected by search, the process advances to step S1 (FIG. 1). In step S1, device B (NS client) issues an NS request to device A (NS server).

In step S2, device A receives the NS request, and determines whether it can execute the NS request. If device A determines that it can execute the NS request, it shifts to the NS server mode to send back an NS response to device B. Then, device A enters the console external controlled mode in which device B controls the console unit 2012 of device A, and device A also enters the virtual scanning mode in which image data received via a network from device B is processed as if it were scanned by device A.

In step S3, device B receives the NS response and enters the NC client mode. Then, device B enters the console client mode in which device B controls the console unit 2012 of device A. At the same time, the scanner 2070 of device B waits for a pull scan request.

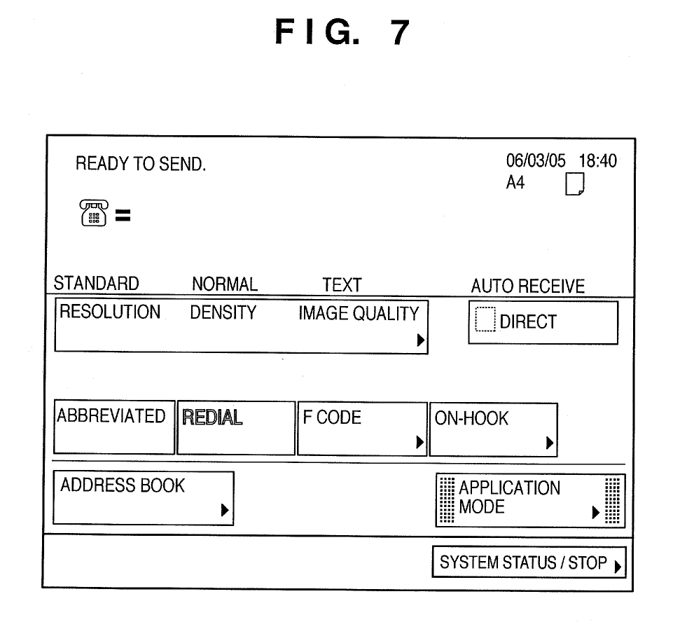

The NS system is built in this state, so the screen of device B displays the FAX operation screen of device A, as shown in FIG. 7.

FIG. 7 depicts a view showing an example of the FAX operation screen displayed on the display 2013 of the console unit of device B.

In step S4, the user of device B controls the console unit of device A via the console unit 2012 of device B, and sets a job for device A. If the user presses the start key 2014 of the console unit 2012 of device B in step S5 upon completion of settings on the operation screen of device A that is displayed on device B, device B notifies device A of the operation information. In step S6, device A issues a pull scan request together with scan parameters to device B to request device B to scan a document.

In step S7, device B receives the pull scan request, and refers to the scan parameters and the like to determine whether it can execute the requested document scanning. If device B determines that it can execute the requested document scanning, it sends back a pull scan response to device A. At the same time, the scanner 2070 of device B scans the document to create pull scan image data, and device B transmits the pull scan image data to device A. If device B determines that it cannot execute the requested document scanning, it notifies device A of a message to this effect together with the reason.

In step S8, device A receives the pull scan image data from device B, and stores it in a memory used to store image data when device A scans and reads a document. This state is equivalent to a state in which the scanner 2070 of device A scans the document.

In step S9, device B scans all designated document sheets, and sends a pull scan end notification to device A. Device B determines that device A completes the FAX transmission job, and in step S10, transmits an NS end request to device A. As a result, the NS system is canceled, and device B ends the console client mode and pull scan mode. In step S11, device A receives the NS end request, and ends the console external controlled mode and virtual scanning mode.

<Continuation of Pull Scan>

The above-described operation is a general one. When, for example, device B scans document sheets one by one without using any ADF, scanning of the document sheet ends every time a 1-page document is scanned. Hence, device B advances to step S9 to notify device A of the end of pull scan. If the user replaces a document sheet and presses the start key 2014 of device B, device B notifies device A of new operation information. In response to this, device A returns again to step S6 to issue a pull scan request to device B. In this manner, even if no ADF is used, the user of device B can operate device B as if device B executed a FAX transmission job.

<Pull Scan Disable Notification>

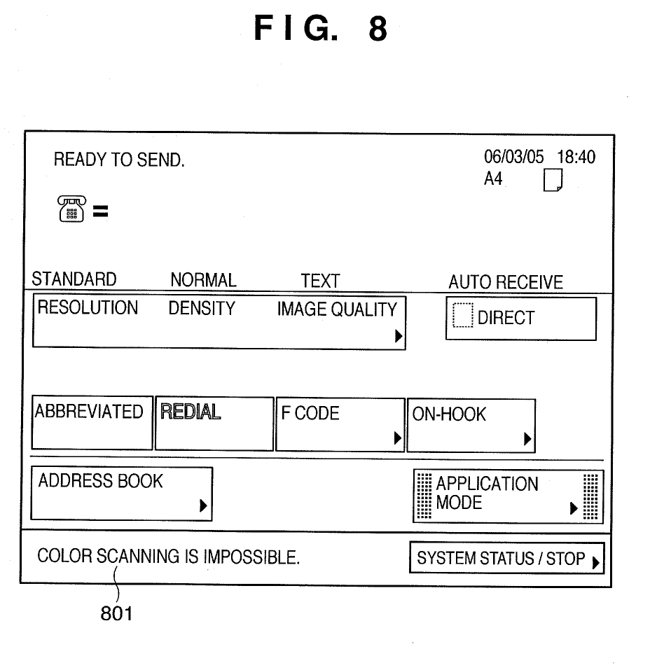

When, for example, color scanning is requested in step S6, but the scanner 2070 of device B has only a monochrome scan function, device B determines that it cannot execute the scan parameters of a pull scan request received from device A. Device B transmits, to device A, a character string representing an impossible parameter. Upon receiving the character string, device A displays it as a warning message 801 as shown in FIG. 8.

FIG. 8 depicts a view showing an example of the display of the warning message displayed on the display 2013 of device A.

A message that “color scanning is impossible” in device B is displayed as the warning message 801.

Since the console unit 2012 of device B also displays this message, the user of device B can cope with the warning as if device B displayed the warning.

Based on the above description, a process in the device (MFP) according to the embodiment will be explained.

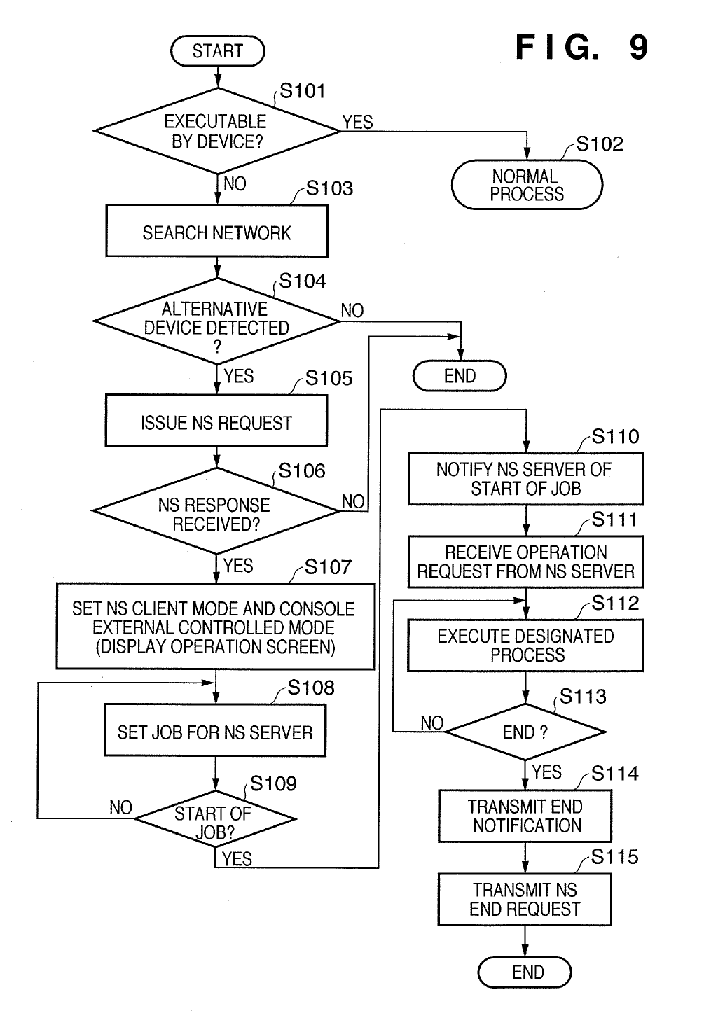

FIG. 9 is a flowchart for explaining a process in the MFP according to the first embodiment. A program for executing this process is installed in the HDD 2004, loaded into the RAM 2002 in execution, and executed under the control of the CPU 2001. The flowchart in FIG. 9 corresponds to a process when the MFP is device B described above.

The process in the flowchart starts when, for example, the user of device B uses the console unit 2012 of device B to input an instruction to request any process. In step S101, device B determines whether it can execute the input instruction. When the FAX function is requested, as described above, if device B is connected to a FAX line and the scanner of device B can scan a document, then device B determines that it can execute the requested function. In this case, the sequence advances to step S102 such that device B executes the requested process. This is a well-known technique, and a description thereof will be omitted.

If device B determines in step S101 that it cannot execute the requested function, the sequence advances to step S103 to search a connected network for another device capable of executing the function. In step S104, device B determines whether another device capable of executing the function is detected. If another device capable of executing the function is detected, the sequence advances to step S105 to issue an NS request to the partner device (device A (NS server) in the example of FIG. 1). If no device capable of executing the function is detected in step S104, or device B does not receive any response to the NS request in the next step S106, device B cannot execute the designated function, the console unit 2012 of device B displays a message to this effect, and the process ends.

If the device B receives an NS response from the partner device in step S106, the sequence advances to step S107 to set device B in the NC client mode and the console client mode in which device B operates the console unit of the partner device (device A). In this case, the console unit 2012 of device B displays the same screen as that on the console unit of the partner device. Then, the sequence advances to step S108 to transmit a job set with the console unit 2012 of device B to the partner NS server and set the job. In step S109, device B determines whether the user has pressed the start key 2014 of the console unit 2012 of device B to designate the start of the job. If the user has not designated the start of the job, the sequence returns to step S108 to execute the above-described process. If the user has designated the start of the job in step S109, the sequence advances to step S110 to notify the NS server that the user has designated the start of the job. In step S111, device B receives the execution request of a process corresponding to the job from the NS server. In the above-described example, this request corresponds to a pull scan request. In step S112, device B executes the designated process. In step S113, device B determines whether the designated process has ended. If the designated process has not ended, the sequence returns to step S112 to execute the aforementioned process. If the designated process has not ended, the sequence returns to step S112 to execute the aforementioned process. If the designated process has ended, the sequence advances to step S114 to notify the partner device of the end of the process. This notification corresponds to a pull scan end notification in the example of FIG. 1. Then, the sequence advances to step S115 to transmit an NS end request to the NS server and end the process.

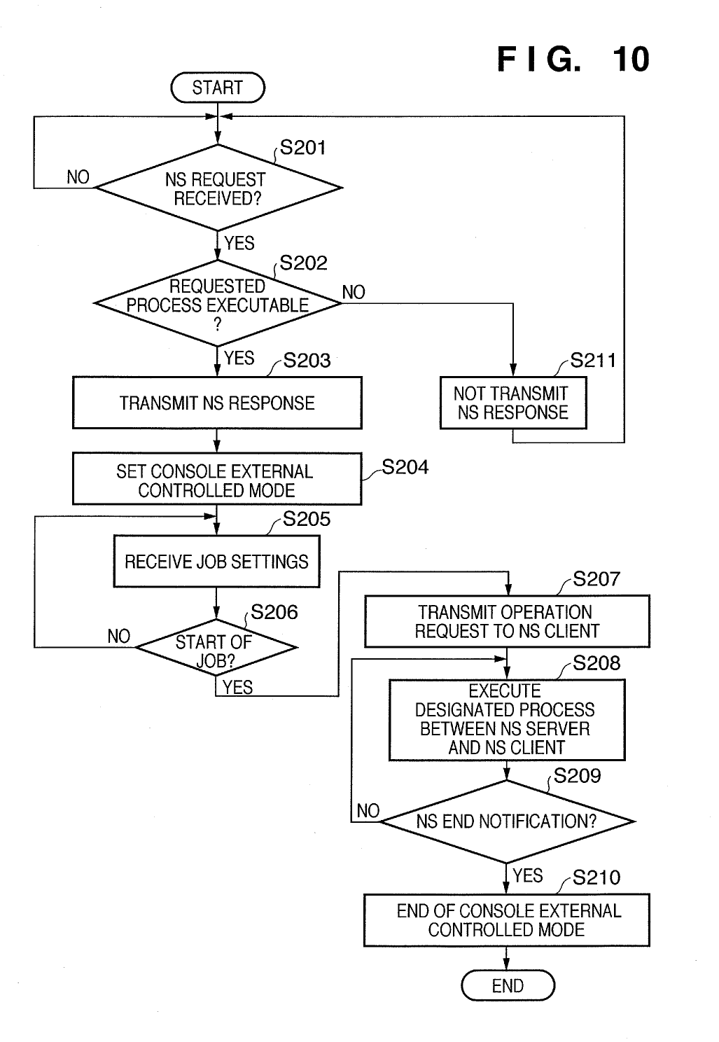

FIG. 10 is a flowchart for explaining a process in the MFP according to the first embodiment. A program for executing this process is installed in the HDD 2004, loaded into the RAM 2002 in execution, and executed under the control of the CPU 2001. The flowchart in FIG. 10 corresponds to a process when the MFP is device A described above.

In step S201, device A determines whether it has received an NS request from a device (device B in the example of FIG. 1) serving as an NS client. If device A has received the NS request, the sequence advances to step S202 to determine whether device A can execute a process requested by the NS request. If device A determines that it can execute the requested process, it transmits an NS response to the requesting device (device B) in step S203. In step S204, device A sets the console external controlled mode, and sets the function of the console unit 2012 of device A so as to run on the console unit of the NS client. Then, the sequence advances to step S205 to receive job settings from the NS client. In step S206, device A waits until it is designated to start the set job.

If the user presses the start key on the console unit 2012 of the NS client (device B), device A receives the job start designation, and the sequence advances to step S207. In step S207, device A issues a process request to the NS client to execute the job. This request corresponds to a pull scan request in the example of FIG. 1. In step S208, device A executes a process corresponding to the designated process to, for example, receive data transmitted from the NS client in accordance with the process request. If device A is notified of the end of the process and the end of the NS in step S209, the sequence advances to step S210 to cancel the console external controlled mode set in step S204, and device A returns to the original operation mode.

If device A determines in step S202 that it cannot execute the process requested by the NS request, the sequence advances to step S211 to notify the NS client that device A cannot execute the requested process, without sending back any NS response. Then, the sequence returns to step S201.

As described above, according to the first embodiment, when a given device cannot execute a requested process, or when a device with high processing capability exists, the given device can execute the process in cooperation with a partner device connected via a network.

### Second Embodiment

In the first embodiment, the NS system is built upon selecting a process function. In the second embodiment, when a given process function is set, the function is displayed without discriminating whether the function is executable by the device or using the NS of an external device. The NS system is built only after making a setting requiring the use of the NS.

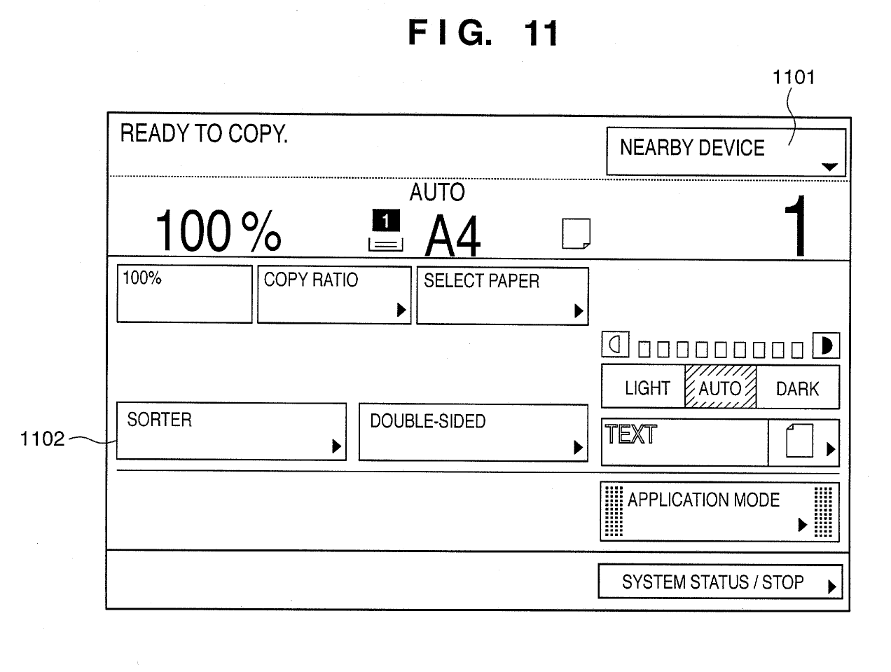

FIG. 11 depicts a view showing an example of a copy function setup screen displayed on a display 2013 of a console unit 2012 of an MFP when a copy icon 501 is designated on the operation screen in FIG. 5.

An execution device indicator 1101 indicates the priority to search for a device by the NS when no device is set. With the execution device indicator 1101, the user can change the search device priority or designate devices which build the NS system. When the user designates specific devices, the designated devices are searched for to build the NS system by the same steps as those in the first embodiment.

Assume that the MFP according to the second embodiment can execute simple “corner staple”, but cannot execute advanced “saddle stitching staple” to “saddle-stitch” print sheets at the center and fold them into two.

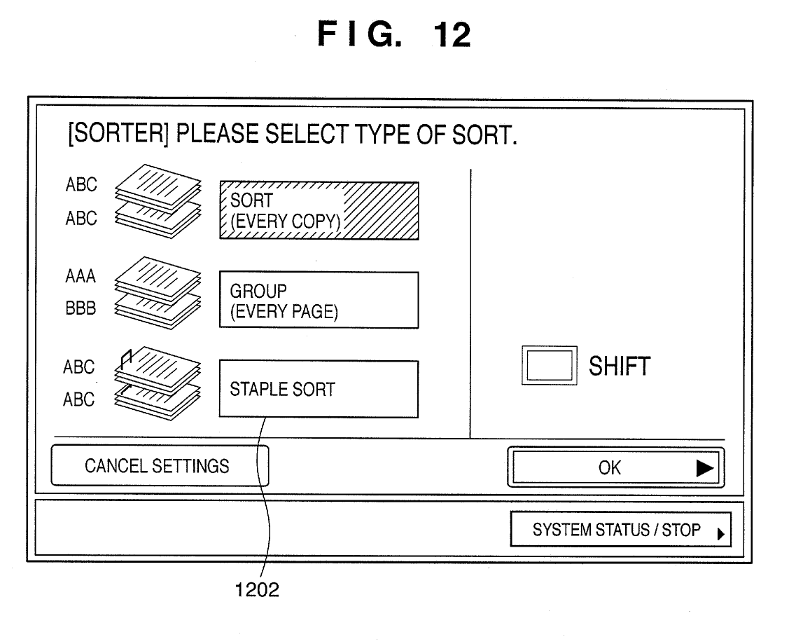

When the user selects “sorter” 1102 in FIG. 11, a sort setup screen shown in FIG. 12 is displayed.

FIG. 12 depicts a view showing an example of the sort setup screen displayed on the console unit 2012 of the MFP according to the second embodiment.

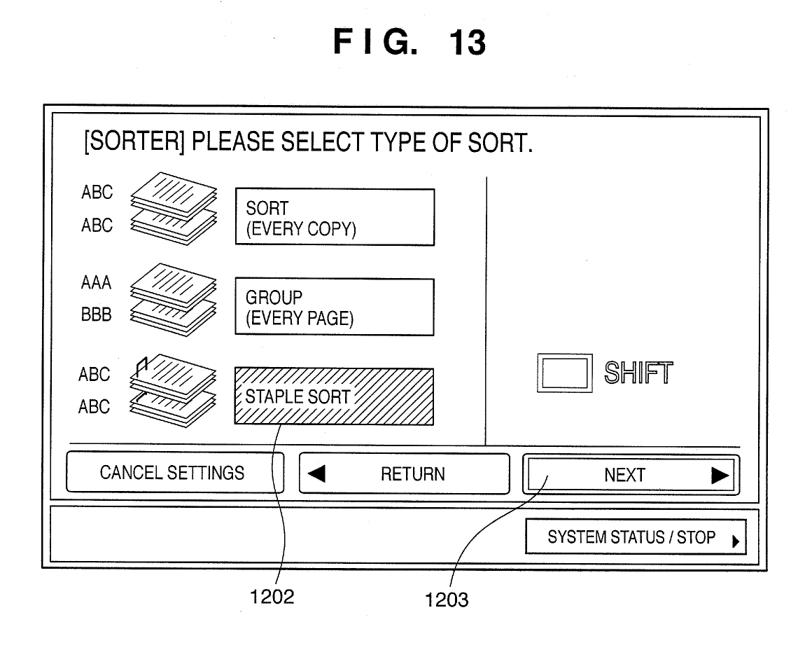

In the default state, “sort (every copy)” 1201 without stapling is set. If the user selects “staple sort” 1202 in FIG. 12, the screen in FIG. 12 changes to one in FIG. 13.

FIG. 13 depicts a view showing an example of the screen when “staple sort” displayed on the console unit 2012 of the MFP is designated according to the second embodiment.

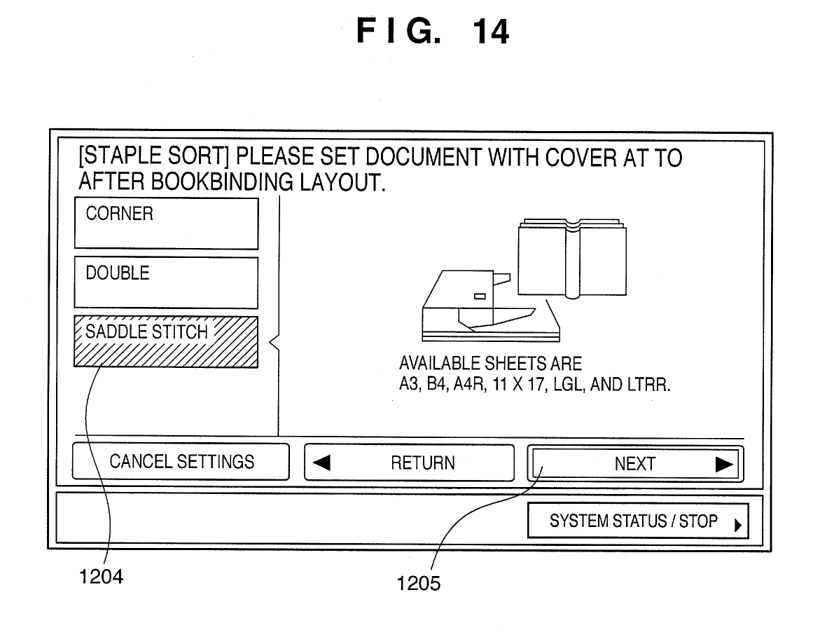

When the user designates “next” 1203 to invoke the next setup screen, the setup screen in FIG. 13 changes to one shown in FIG. 14.

FIG. 14 depicts a view showing an example of the staple sort setup screen displayed on the console unit 2012 of the MFP according to the second embodiment.

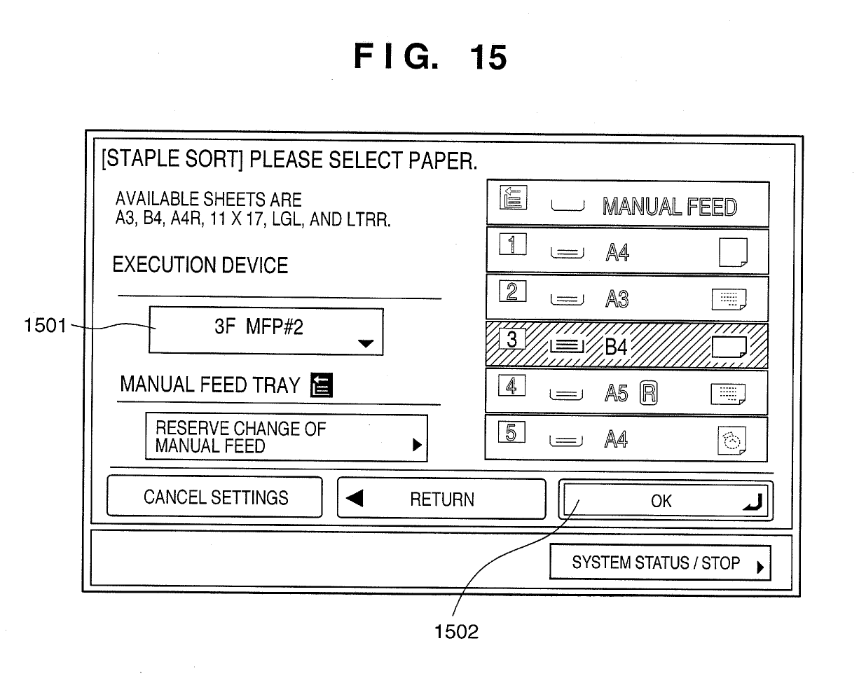

When the user selects “saddle stitch” 1204 and designates “next” 1205 to invoke the next setup screen, an NS capable of executing “saddle stitching staple” is searched for by the same steps as those described in the first embodiment. If a device for executing the function is detected as a result of the search, a screen in FIG. 15 is displayed.

FIG. 15 depicts a view showing an example of a screen for selecting the size of a print sheet (paper) subjected to stapling and sorting by the detected device.

An execution device indicator 1501 synchronizes with the execution device indicator 1101 in FIG. 11. A device indicated by the execution device indicator 1501 is one which can execute a currently set function and has the highest priority in the designated search order. Another execution device is also selectable by changing the contents of the execution device indicator 1501.

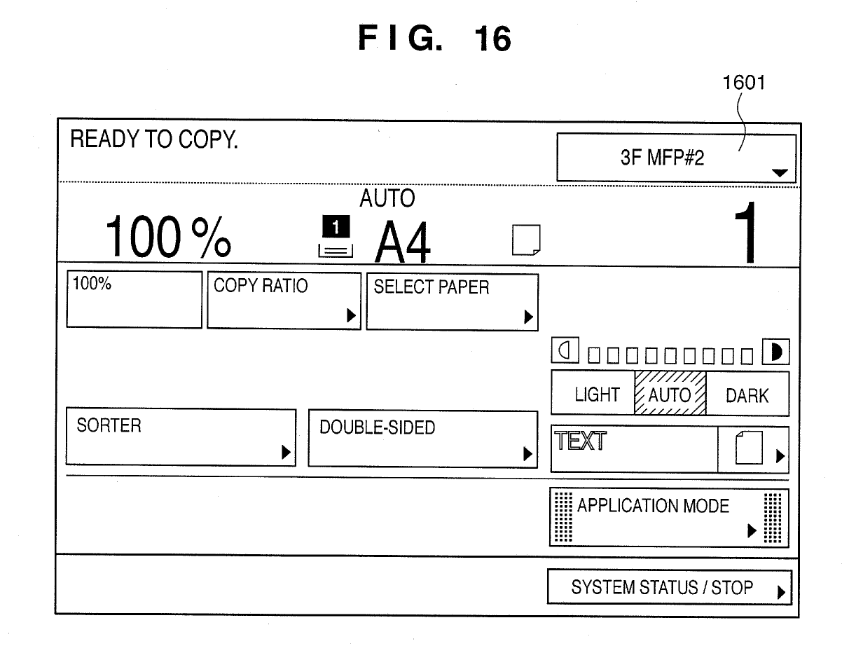

If the user designates “OK” 1502 in the state of FIG. 15, an NS system to be executed is built to display a screen shown in FIG. 16 through the same process as that described in the first embodiment.

FIG. 16 depicts a view showing an example of the operation screen when the execution device executes a copy process.

In FIG. 16, an execution device indicator 1601 indicates the same device as that by the execution device indicator 1501 in FIG. 15. The device indicated by the execution device indicator 1601 executes copy and “saddle stitching staple” of copied sheets.

As described above, according to the second embodiment, a device can set a partner device using the virtual scanning mode and a control scheme (e.g., VNC) of controlling the console unit of the partner device. These devices can cooperate with each other via a network to implement a desired process. For example, a device actually operated by the user scans a document, and the partner device stores and transmits the scanned image data. Even when a new service is added to the cooperating destination device, the cooperating source device can utilize the service without exchanging a new capability exchange protocol. A program for using the new service need not be installed in the cooperating source, and the cooperating source can use the operation screen and operation program of the cooperating destination. The second embodiment can provide a cooperating system in which devices grasp their partner's capabilities without using any capability exchange protocol between them, and devices for the cooperating system. The second embodiment can easily implement processes based on the combination of the scanner capability of the cooperating device and the scanned image processing capability of the cooperating device, and can implement a variety of processes by freely selecting the combination of devices. Since the cooperating function between devices is implemented by organically combining original functions (VNC function, pull scan function, and scanned image process function) of the cooperating destination device, the number of new design steps does not increase greatly.

### Other Embodiments

The present invention may be applied to a system including a plurality of devices or an apparatus formed by a single device.

The present invention is also achieved by supplying a software program for implementing the functions of the above-described embodiments to a system or apparatus directly or from a remote place, and reading out and executing the supplied program by the computer of the system or apparatus. In this case, the form of the present invention is not limited to the program as long as a program function is attained.

The present invention is therefore implemented by program codes installed in the computer in order to implement functional processes of the present invention by the computer. That is, the appended claims of the present invention also include a computer program for implementing functional processes of the present invention. In this case, the present invention can take any program form such as an object code, a program executed by an interpreter, or script data supplied to an OS as long as a program function is attained.

As a recording medium for supplying the program, various recording media are available. Examples of the recording medium are a Floppy® disk, hard disk, optical disk, magnetooptical disk, MO, CD-ROM, CD-R, CD-RW, magnetic tape, nonvolatile memory card, ROM, and DVD (DVD-ROM and DVD-R).

As another program supply method, the program can also be supplied by connecting a client computer to an Internet homepage via the browser of the client computer, and downloading the program from the homepage to a recording medium such as a hard disk. In this case, the downloaded program may be the computer program of the present invention or a compressed file containing an automatic installing function. The program can also be implemented by grouping program codes which form the program of the present invention into a plurality of files, and downloading the files from different homepages. That is, the appended claims of the present invention also incorporate a WWW server which allows a plurality of users to download the program files for implementing functional processes of the present invention by a computer.

The program of the present invention can be encrypted, stored in a storage medium such as a CD-ROM, and distributed to a user. A user who satisfies predetermined conditions is prompted to download decryption key information from a homepage via the Internet. The user executes the encrypted program using the key information, and installs the program in the computer.

The functions of the above-described embodiments are also implemented in a form other than one in which the computer executes the readout program. For example, the functions of the above-described embodiments are implemented when an OS or the like running on the computer performs some or all of actual processes based on the instructions of the program codes.

The program read out from the recording medium may be written in the memory of a function expansion board inserted into the computer or the memory of a function expansion unit connected to the computer. In this case, the CPU of the function expansion board or function expansion unit performs some or all of actual processes based on the instructions of the program codes, thereby implementing the functions of the above-described embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims priority from Japanese Patent Application No. 2006-169388, filed Jun. 19, 2006, which is hereby incorporated by reference herein in its entirety.

1. An image processing apparatus which has at least a console unit and an image scanner and can connect to a network, comprising:
a creation unit configured to create image data corresponding to a document by driving the image scanner in accordance with a scan parameter upon receiving an image scan request including the scan parameter of the document;
a transmission unit configured to transmit the image data created by said creation unit to a transmitting source which has issued the image scan request via the network; and
a notification unit configured to notify the transmitting source to process an operation using the console unit as an operation on a console unit of the transmitting source.

2. The apparatus according to claim 1, further comprising:
a unit configured to transmit a network service request to the transmitting source; and
a unit configured to set a client mode of the network service in a case that the transmitting source accepts the network service request.

3. An image processing apparatus which has at least a console unit and an image scanner and can connect to a network, comprising:
a request issuance unit configured to issue an image scan request including a scan parameter of a document to a partner device via the network;
a reception unit configured to receive, via the network, image data scanned by the partner device in response to the scan request;
a processing unit configured to process the image data received by said reception unit as image data scanned by the image scanner; and
an operation control unit configured to, upon receiving operation information on a console unit of the partner device, processing the operation information as if the same operation were performed on the console unit of the image processing apparatus.

4. The apparatus according to claim 3, further comprising:
a unit configured to receive a network service request from the partner device; and
a determination unit configured to determine whether the network service request can be met,
wherein in a case that said determination unit determines that the network service request can be met, processes by said reception unit, said processing unit, and said operation control unit are executed.

5. A control method in an image processing apparatus which has at least a console unit and an image scanner and can connect to a network, comprising:
a creation step of creating image data corresponding to a document by driving the image scanner in accordance with a scan parameter upon receiving an image scan request including the scan parameter of the document;
a transmission step of transmitting the image data created in said creation step to a transmitting source which has issued the image scan request via the network; and
a notification step of notifying the transmitting source to process an operation using the console unit as an operation on a console unit of the transmitting source.

6. The method according to claim 5, further comprising:
a step of transmitting a network service request to the transmitting source; and
a step of setting a client mode of the network service in a case that the transmitting source accepts the network service request.

7. A control method in an image processing apparatus which has at least a console unit and an image scanner and can connect to a network, comprising:
a request issuance step of issuing an image scan request including a scan parameter of a document to a partner device via the network;
a reception step of receiving, via the network, image data scanned by the partner device in response to the scan request;
a processing step of processing the image data received in said reception step as image data scanned by the image scanner; and
an operation control step of, upon receiving operation information on a console unit of the partner device, processing the operation information as if the same operation were performed on the console unit of the image processing apparatus.

8. The method according to claim 7, further comprising:
a step of receiving a network service request from the partner device; and
a determination step of determining whether the network service request can be met,
wherein in a case that the network service request is determined in said determination step to be able to be met, processes in said reception step, said processing step, and said operation control step are executed.

9. An image processing system having a plurality of image processing apparatuses connected via a network, comprising:
a first setting unit configured to set a first apparatus and a second apparatus in a client mode and a server mode, respectively, by requesting a network service of the second apparatus from the first apparatus;
a second setting unit configured to set, in accordance with the request, a mode in which a console unit of the second apparatus is controlled from a console unit of the first apparatus, and image data scanned and created by an image scanner of the first apparatus is processed as image data scanned by an image scanner of the second apparatus;
a third setting unit configured to set, in the second apparatus, setting information set using the console unit of the first apparatus;
a designation unit configured to designate the first apparatus from the second apparatus to scan an image using the image scanner of the first apparatus in response to process start designation input from the console unit of the first apparatus;
a transmission unit configured to transmit the image data scanned by the image scanner of the first apparatus to the second apparatus in response to designation from said designation unit; and
a control unit configured to control the second apparatus to execute a process corresponding to the setting information for the image data transmitted by said transmission unit.
